(19) United States
(12) Patent Application Publication
(10) Pub. No.: US 2014/0044995 A1
(43) Pub. Date: Feb. 13, 2014

(54) BATTERY PACK

(71) Applicant: SAMSUNG SDI CO., LTD., Yongin-si (KR)

(72) Inventors: Dae-Yon Moon, Yongin-si (KR); Hee-Youn Won, Yongin-si (KR)

(21) Appl. No.: 13/941,388

(22) Filed: Jul. 12, 2013

Related U.S. Application Data
(60) Provisional application No. 61/681,862, filed on Aug. 10, 2012.

(51) Int. Cl. H01M 2/10

(52) U.S. Cl. CPC H01M 2/1022
USPC 429/7

(57) ABSTRACT

A battery pack includes a case; a plurality of battery cells accommodated in the case; a protection circuit module electrically connected to the plurality of battery cells; and a spacer located between neighboring battery cells and electrically insulating the battery cells from each other, wherein a width of at least one of an upper portion and a lower portion extending along a length of each spacer is greater than a width of a center portion of the spacer, and wherein a side surface of at least one of the upper portion and the lower portion of the spacer is rounded.

### CROSS-REFERENCE TO RELATED APPLICATION

This application claims priority to and the benefit of U.S. Provisional Application No. 61/681,862, filed on Aug. 10, 2012 in the U.S. Patent and Trademark Office, the entire content of which is incorporated herein by reference.

### BACKGROUND

1. Field

One or more embodiments of the present invention relate to a battery pack.

2. Description of Related Art

As wireless Internet and communication technology have developed, a supply of portable computers capable of operating by using a battery and not a power supply unit requiring connection to an outlet is rapidly increasing. In general, portable computers are small and easy to carry, and thus the portable computers are widely used for business use or individual use. Portable computers may include a battery pack embedded therein in order to be used in various places regardless of availability of a power supply unit. Also, an embedded battery pack may include a battery cell that may be repeatedly charged/discharged.

### SUMMARY

According to one or more embodiments of the present invention, a battery pack includes a case; a plurality of battery cells accommodated in the case; a protection circuit module electrically connected to the plurality of battery cells; and spacers located between side surfaces of the neighboring battery cells and electrically insulating the battery cells, wherein a width of at least one of an upper portion and a lower portion of the spacer formed in a thickness direction of the battery cells is greater than a width of a center portion of the spacer, and a side surface of at least one of the upper portion and the lower portion of the spacer has a round shape.

A radius of curvature of the side surface of the at least one of the upper portion and the lower portion of the spacer may be equal to or greater than a radius of curvature of a corner portion of the battery cell adjacent to the spacer.

A side surface of the spacer may cover side surfaces of the battery cells located at both sides of the spacer.

A protrusion may be formed from the side surface of the at least one of the upper portion and the lower portion of the spacer toward the battery cells.

The spacer may further include a blocking unit integrally formed with the spacer and extending in a direction perpendicular to a length direction of the spacer.

The spacer including the blocking unit may be T-shaped as a whole, and a first surface of the blocking unit may contact one surfaces of a first battery cell and a second battery cell located at both sides of the spacer.

The spacer including the blocking unit may be L-shaped as a whole, and the first surface of the blocking unit may contact one surfaces of the first battery cell and the second battery cell located at both sides of the spacer.

The first surface of the blocking unit may contact one surface of at least one of the first battery cell and the second battery cell located at both sides of the spacer, and a second surface of the blocking unit on the opposite side of the first surface may contact an inner surface of the case.

The protection circuit module may be located on one side of the battery cells.

A length of the spacer may be greater than lengths of the battery cells, and one end portion of the spacer may extend longer than the battery cells toward the protection circuit module.

The battery pack may further include fixing tapes for fixing the spacers and the battery cells located at both sides of the spacers.

According to one or more embodiments of the present invention, a battery pack includes a plurality of battery cells arranged side-by-side in one direction; a protection circuit module electrically connected to the plurality of battery cells; and spacers located between side surfaces of the neighboring battery cells, covering a side surface of each of the battery cells located at both sides of the spacers, and including insulation materials, wherein each of the battery cells includes an electrode assembly including a positive electrode plate, a negative electrode plate, and a separator located between the negative and positive electrode plates, and a can for accommodating the electrode assembly, wherein a width of at least one of an upper portion and a lower portion of the spacer formed in a thickness direction of the battery cells is greater than a width of a center portion of the spacer and is I-beam shaped as a whole, and a side surface of at least one of the upper portion and the lower portion of the spacer has a round shape.

The can may include a metallic material.

A radius of curvature of the side surface of the at least one of the upper portion and the lower portion of the spacer may be equal to or greater than a radius of curvature of a corner portion of the battery cells adjacent to the spacer.

A protrusion may be formed from the side surface of the at least one of the upper portion and the lower portion of the spacer toward the battery cells.

The spacer may further include a blocking unit integrally formed with the spacer and extending in a direction perpendicular to a length direction of the spacer.

The blocking unit may contact one surface of one of the battery cells located at both sides of the spacer.

A length of the spacer may be greater than lengths of the battery cells, and one end portion of the spacer may extend longer than the battery cells toward the protection circuit module.

According to one or more embodiments of the present invention, a battery pack includes a plurality of battery cells arranged side-by-side in one direction; a protection circuit module electrically connected to the plurality of battery cells; and spacers located between side surfaces of the neighboring battery cells and covering a side surface of each of the battery cells located at both sides of the spacers, wherein corner portions of the battery cells have round shapes, wherein a side surface of at least one of an upper portion and a lower portion of the spacer has a round shape, and wherein a radius of curvature of the side surface of the at least one of the upper portion and the lower portion of the spacer is equal to or greater than a radius of curvature of the corner portion of the battery cell adjacent to the spacer.

A protrusion may be formed from the side surface of the at least one of the upper portion and the lower portion of the spacer toward the battery cells.

### BRIEF DESCRIPTION OF THE DRAWINGS

FIG. 1 is an exploded perspective view of a battery pack according to an embodiment of the present invention.

FIG. 2 is a perspective view of a spacer of FIG. 1.

FIG. 3 is a perspective view of a spacer according to another embodiment of the present invention.

FIG. 4 is a top view of the spacers of FIG. 2 located between battery cells.

FIG. 5 is a schematic cross-sectional view of a spacer that is to be located between neighboring battery cells.

FIG. 6 is a cross-sectional view of a spacer located between neighboring battery cells taken along line VI-VI of FIG. 4.

### DETAILED DESCRIPTION

Hereinafter, the present invention will be described in detail by explaining embodiments of the invention with reference to the attached drawings. The invention may, however, be embodied in many different forms and should not be construed as being limited to the embodiments set forth herein; rather, these embodiments are provided so that this disclosure will be thorough and complete, and will fully convey the concept of the invention to one of ordinary skill in the art. Meanwhile, the terminology used herein is for the purpose of describing particular embodiments and is not intended to limit the invention. As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Also, it will be understood that, although the terms ‘first’, ‘second’, etc. may be used herein to describe various elements, these elements should not be limited by these terms. These terms are only used to distinguish one element from another.

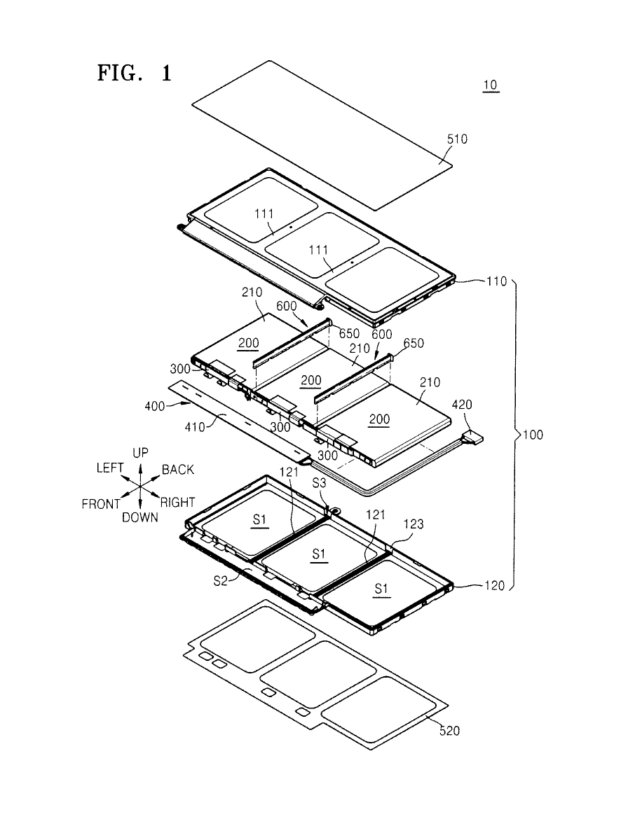

FIG. 1 is an exploded perspective view of a battery pack 10 according to an embodiment of the present invention.

Referring to FIG. 1, the battery pack 10 may include a case 100, a plurality of battery cells 200 accommodated in the case 100, a protection circuit module 400, and a plurality of spacers 600 located between the neighboring battery cells 200.

The case 100 may accommodate the plurality of battery cells 200 and the protection circuit module 400. The exterior of the battery cells 200 accommodated in the case 100 may be manufactured as a can 210 including a metallic material. In this regard, the case 100 may include an insulation material so as to prevent an unnecessary electrical connection with the battery cells 200. For example, the case 100 may be formed by injection molding.

The case 100 may include an upper case 110 and a lower case 120. The upper case 110 and the lower case 120 may be coupled to each other through a hook structure formed along a side surface of the upper case 110 and the lower case 120. The lower case 120 may include a space S1 in which the battery cells 200 may be safely received and a space S2 in which the protection circuit module 400 may be safely received.

To minimize the whole thickness of the case 100, a region of a top surface of the upper case 110 or a bottom surface of the lower case 120 that corresponds to top surfaces or bottom surfaces of the battery cells 200 respectively is open. Ribs 111 and 121 that correspond to the spacers 600 may be respectively formed in the top surface of the upper case 110 and the bottom surface of the lower case 120. The open regions of the upper case 110 and the lower case 120 may be covered by labels 510 and 520 respectively attached to the upper case 110 and the lower case 120.

The battery cells 200 may be rechargeable secondary batteries and include lithium-ion batteries. The battery cells 200 include an electrode assembly and the can 210 for accommodating the electrode assembly. The electrode assembly may be manufactured by stacking a positive electrode plate, a negative electrode plate, and a separator located between the negative and positive electrode plates and winding the positive electrode plate, the negative electrode plate, and the separator in the form of a jelly roll. The can 210 may be formed of a metallic material. For example, the can 210 may be formed of aluminum or aluminum alloy but is not limited thereto.

The plurality of battery cells 200 may be arranged side-by-side in one direction. Particularly, the battery cells 200 may be arranged side-by-side such that a positive electrode and a negative electrode may be located on a front surface of each of the battery cells 200. For example, the plurality of battery cells 200 may be connected in series to each other by lead plates 300.

Although the present embodiment describes a case where three battery cells 200 are connected in series to each other and form the single battery pack 10, the number of or how to connect the battery cells 200 included in the battery pack 10 is not limited thereto and may be implemented in various ways.

The protection circuit module 400 may be electrically connected to the plurality of battery cells 200. The protection circuit module 400 may prevent the battery cells 200 from overheating and exploding due to over-charge, over-discharge, or over-current. The protection circuit module 400 may include a substrate 410 and a protection device mounted on one side or in the substrate 410. The protection device may selectively include a safety device including a passive device such a resistor and a capacitor or an active device such as a thin film transistor (TFT) or integrated circuits.

A connector 420 may be located on one side of the protection circuit module 400 to supply power to an external electronic device.

The spacers 600 may be located between the neighboring battery cells 200 and insulate the battery cells 200 from each other. As described above, the exterior of the battery cells 200 is the can 210 formed of the metallic material, and thus the spacers 600 may be located in order to insulate the battery cells 200 arranged side-by-side. To this end, the spacers 600 may include an insulation material such as plastic.

The spacers 600 may be generally elongate and may include blocking units 650 at one or both of the ends. One surface of the blocking units 650 may contact back surfaces of the battery cells 200. In addition, a space S3 may be formed in one side of the lower case 120 such that the blocking units 650 may be stably received therein, and thus other surfaces of the blocking units 650 may contact an inner surface 123 of the lower case 120.

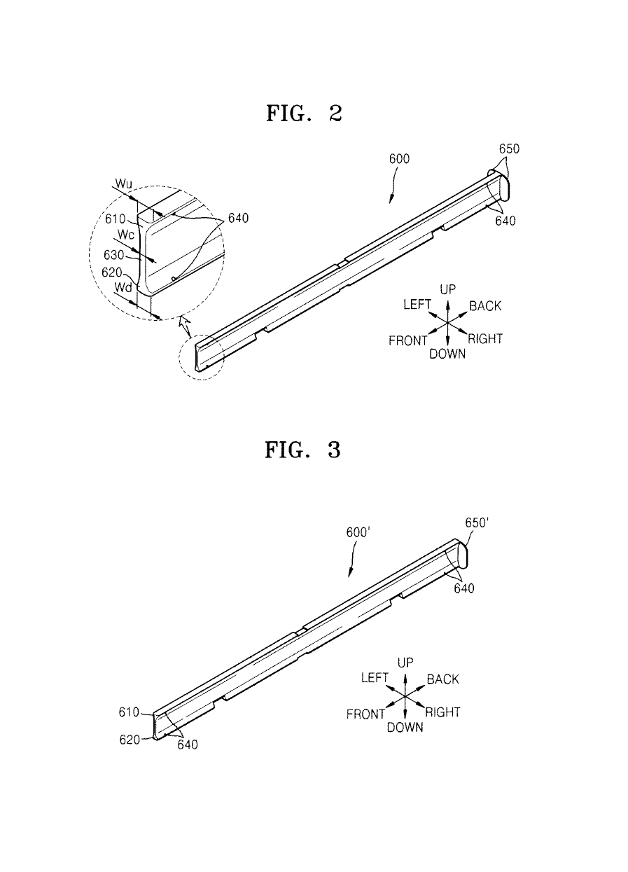

FIG. 2 is a perspective view of the spacer 600 of FIG. 1. FIG. 3 is a perspective view of the spacer 600 according to another embodiment of the present invention.

Referring to FIG. 2, the spacer 600 may extend long in front and back directions, i.e., the spacer is generally elongate. A cross-section of the spacer 600 may have an I-beam shape as a whole. For example, a width Wu of an upper portion 610 of the spacer 600 and a width Wd of a lower portion 620 thereof may be greater than a width We of a center portion 630 thereof.

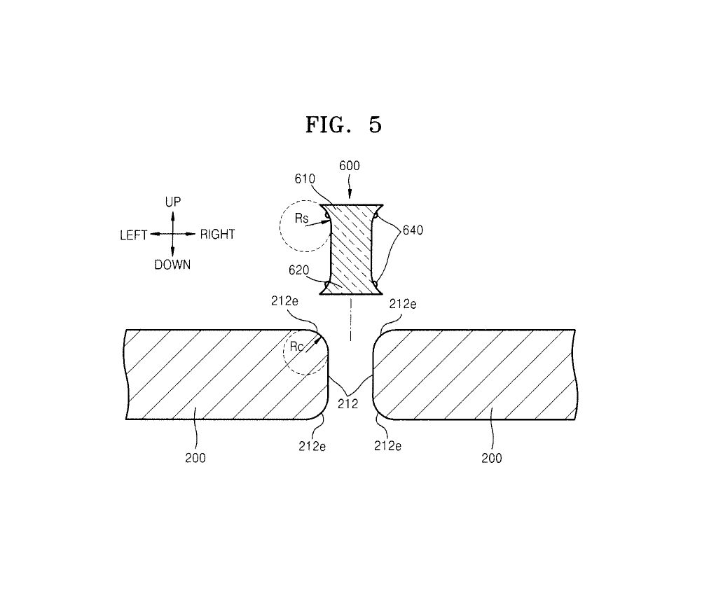

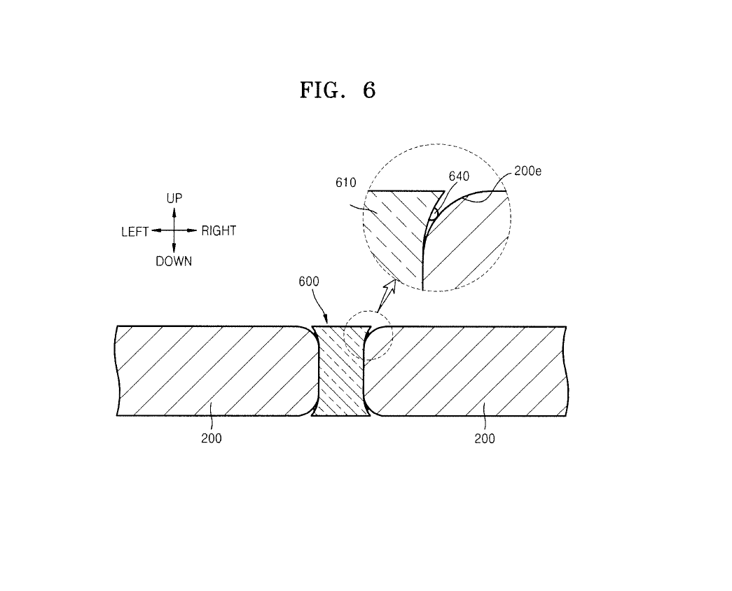

Side surfaces of the upper portion 610 and the lower portion 620 of the spacer 600 may have round shapes. That is, the side surfaces of the upper portion 610 and the lower portion 620 of the spacer 600 may include curved surfaces. Corner portions of the battery cells 200 at both sides of the spacer 600 have round shapes, and thus the side surfaces of the upper portion 610 and the lower portion 620 of the spacer 600 may include curved surfaces such that the spacer 600 may stably cover side surfaces of the battery cells 200. The round shapes of the upper portion 610 and the lower portion 620 of the spacer 600 and a structure of the spacer 600 that covers the side surfaces of the battery cells 200 will be described below with reference to FIGS. 5 and 6.

Protrusions 640 may be formed on side surfaces of the upper portion 610 and the lower portion 620 of the spacer 600. When the spacer 600 is located between the neighboring battery cells 200, there may be a gap between a side surface of the spacer 600 and side surfaces of the battery cells 200 according to a manufacturing tolerance. In this case, the spacer 600 may not be stably located between the battery cells 200 so that the spacer 600 may not electrically insulate the neighboring battery cells 200 for a long period, and thus the protrusions 640 may be located on a side surface of the upper portion 610 of the spacer 600 and/or a side surface of the lower portion 620 thereof in order to compensate for the manufacturing tolerance.

The blocking unit 650 may be formed on one side of the spacer 600. The blocking unit 650 may extend in a direction generally perpendicular to a length direction of the spacer 600. For example, the blocking unit 650 may extend in left and right directions so that the spacer 600 may be T-shaped as a whole.

The blocking unit 650 extending in the left and right directions may contact rear surfaces of the battery cells 200 located at both sides of the spacer 600.

As another embodiment of the present invention, referring to FIG. 3, a blocking unit 650′ of the spacer 600′ may be perpendicular to a length direction of the spacer 600′ while extending only in one direction, for example to the right or left of the spacer body. In this regard, the blocking unit 650′ of the spacer 600′ may contact a rear surface of one of the battery cells 200 located at one side of the spacer 600′.

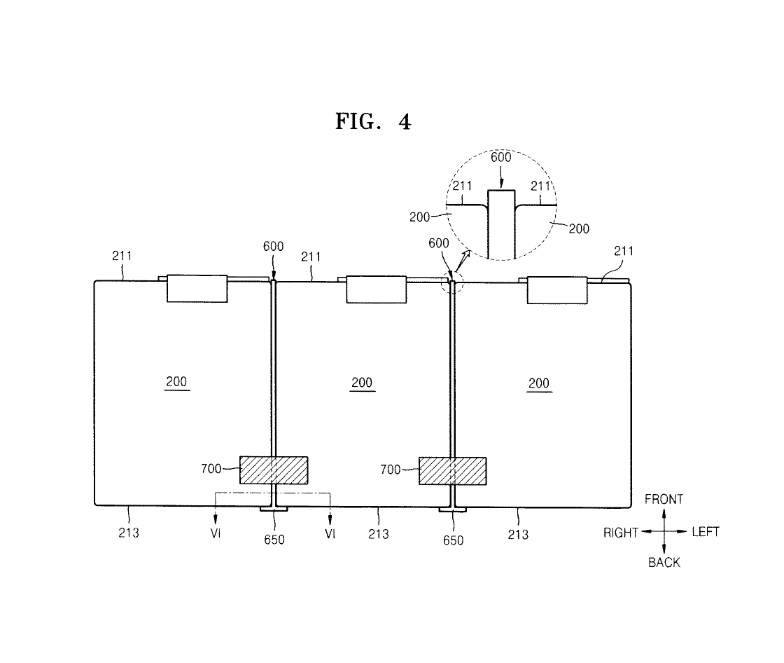

FIG. 4 is a top view of the spacers 600 of FIG. 2 located between the battery cells 200. For descriptive convenience, the lead plates 300 for electrical connections (for example, serial connections) of the plurality of battery cells 200 are not shown in FIG. 4.

Referring to FIG. 4, the spacers 600 may be located between the battery cells 200. For example, the spacers 600 may be located between side surfaces of the battery cells 200. The blocking units 650 formed on one end portion of the spacers 600 may contact rear surfaces of the battery cells 200 located at both sides of the spacers 600.

In a case where the spacer 600, including the blocking unit 650, is T-shaped as a whole, as shown in FIG. 2, one of the ends of the blocking units 650 extending in a left direction may contact rear surfaces 213 of the battery cells 200 located on a left side of the spacers 600, and the other ends of the blocking units 650 extending in a right direction may contact the rear surfaces 213 of the battery cells 200 located on a right side of the spacers 600.

According to another embodiment, in a case where the spacer 600′, including the blocking unit 650′, is L-shaped as a whole, as shown in FIG. 3, one of the ends of the blocking units 650 extending in the right direction (or in the left direction) may contact the rear surfaces 213 of the battery cells 200 located on a right side (or a left side) of the spacers 600.

The battery cells 200 arranged side-by-side may be connected in series to each other by the lead plates 300 as shown in FIG. 1. The battery cells 200 connected in series to each other may be electrically connected to the protection circuit module 400. In this regard, the protection circuit module 400 may be located in front of the battery cells 200.

Lengths of the spacers 600 may be equal to or greater than a length of the battery cells 200. In a case where the lengths of the spacers 600 are greater than the length of the battery cells 200, the other ends of the spacers 600 on the opposite side of the blocking units 650 may extend past the battery cells 200 toward the protection circuit module 400. Thus, the other ends of the spacers 600 on the opposite side of the blocking units 650 may further protrude than front surfaces 211 of the battery cells 200 (see a magnified view of FIG. 4).

Adhesive tapes 700 may be adhered to the spacers 600 and top portions of the battery cells 200 located at both sides of the spacers 600 to connect the spacers 600 and the battery cells 200 to each other.

FIG. 5 is a schematic cross-sectional view of the spacer 600 that is to be located between the neighboring battery cells 200. FIG. 6 is a cross-sectional view of the spacer 600 located between the neighboring battery cells 200 taken along line VI-VI of FIG. 4.

Referring to FIG. 5, corner portions 212e of the battery cells 200 may have round shapes and may have predetermined curvatures Rc. The upper portion 610 and/or the lower portion 620 of the spacer 600 may have a side surface having a curvature in order to allow the round-shaped battery cells 200 to be stably located and electrically insulate the battery cells 200 from each other.

A curvature Rs of a side surface of the upper portion 610 and/or a side surface of the lower portion 620 of the spacer 600 may be equal to or greater than the curvatures Rc of the corner portions 212e of the battery cells 200. The curvature Rs of the side surface of the upper portion 610 and/or the side surface of the lower portion 620 of the spacer 600 may be equal to the curvatures Rc of the corner portions 212e of the battery cells 200 so that the spacer 600 stably covers side surfaces 212 of the battery cells 200 located at both sides of the spacer 600.

According to another embodiment, the curvature Rs of the side surface of the upper portion 610 and/or the side surface of the lower portion 620 of the spacer 600 may be greater than the curvatures Rc of the corner portions 212e of the battery cells 200 in consideration of a manufacturing tolerance of the spacer 600 and an assembly tolerance of the battery cells 200 and the spacer 600. Since the curvature Rs of the side surface of the upper portion 610 and/or the side surface of the lower portion 620 of the spacer 600 may be greater than the curvatures Rc of the corner portions 212e of the battery cells 200, the spacer 600 may be stably located between the neighboring battery cells 200 and cover the side surfaces 212 of the battery cells 200.

In this regard, the protrusion 640 may compensate for a gap between the side surface of the upper portion 610 and/or the side surface of the lower portion 620 of the spacer 600 and the side surfaces 212 of the battery cells 200, as shown in a magnified view of FIG. 6. The protrusion 640 is formed from the side surface of the upper portion 610 and/or the side surface of the lower portion 620 of the spacer 600 toward the side surfaces 212 of the battery cells 200, thereby compensating for the gap due to a difference in the curvatures Rc of the corner portions 212e of the battery cells 200.

It should be understood that the exemplary embodiments described therein should be considered in a descriptive sense only and not for purposes of limitation. Descriptions of features or aspects within each embodiment should typically be considered as available for other similar features or aspects in other embodiments.

[Explanation of Reference Numerals]

| | |
|---|---|
| 10: battery pack | 100: case |

| | |
|---|---|
| 110: upper case | 120: lower case |
| 200: battery cell | 300: lead plate |
| 400: protection circuit module | 410: substrate |
| 420: connector | 510, 520: label |

| | |
|---|---|
| 600: spacer | 650: blocking unit |

700: adhesive tape

1. A battery pack comprising:
a case;
a plurality of battery cells accommodated in the case;
a protection circuit module electrically connected to the plurality of battery cells; and
a spacer located between neighboring battery cells and electrically insulating the battery cells from each other,
wherein a width of at least one of an upper portion and a lower portion extending along a length of each spacer is greater than a width of a center portion of the spacer, and wherein a side surface of at least one of the upper portion and the lower portion of the spacer is rounded.

2. The battery pack of claim 1, wherein a radius of curvature of the side surface of at least one of the upper portion and the lower portion of the spacer is equal to or greater than a radius of curvature of a corner portion of the battery cell adjacent to the spacer.

3. The battery pack of claim 1, wherein a side surface of the spacer covers a side surface of the battery cells located at both sides of the spacer.

4. The battery pack of claim 1, wherein at least one of the upper portion and the lower portion of the spacer further comprises a protrusion, and the protrusion protrudes toward the battery cells to compensate for a gap between the space and the battery cells.

5. The battery pack of claim 1, wherein the spacer further comprises a blocking unit integral with the spacer and extending in a direction generally perpendicular to a length direction of the spacer.

6. The battery pack of claim 5, wherein the spacer comprising the blocking unit is T-shaped, and wherein the blocking unit contacts a first battery cell and a second battery cell located on either side of the spacer.

7. The battery pack of claim 5, wherein the spacer comprising the blocking unit is L-shaped, and the first surface of the blocking unit contacts one of a first battery cell and a second battery cell located adjacent to the spacer.

8. The battery pack of claim 5, wherein the blocking unit comprises a first surface facing a first direction and a second surface facing an opposite second direction, wherein the first surface contacts at least one of a first battery cell and a second battery cell located adjacent to the spacer, and the second surface contacts an inner surface of the case.

9. The battery pack of claim 1, wherein the protection circuit module is located on one side of the battery cells.

10. The battery pack of claim 9, wherein a length of the spacer is greater than a length of the battery cells, and wherein one end portion of the spacer protrudes past the battery cells toward the protection circuit module.

11. The battery pack of claim 1, wherein the battery pack further comprises fixing tape for fixing together the spacer and the battery cells located adjacent to each spacer.

12. A battery pack comprising:
a plurality of battery cells arranged side-by-side in a first direction;
a protection circuit module electrically connected to the plurality of battery cells; and
a spacer located between neighboring battery cells, covering a side surface of each of the neighboring battery cells, and comprising an insulation material, wherein each of the battery cells includes an electrode assembly comprising a positive electrode plate, a negative electrode plate, and a separator located between the negative electrode plate and the positive electrode plate, and a can accommodating the electrode assembly, and
wherein a width of at least one of an upper portion and a lower portion extending along a length of each spacer is greater than a width of a center portion of the spacer and is I-beam shaped, and wherein a side surface of at least one of the upper portion and the lower portion of the spacer is rounded.

13. The battery pack of claim 12, wherein the can comprises a metallic material.

14. The battery pack of claim 12, wherein a radius of curvature of the side surface of at least one of the upper portion and the lower portion of the spacer is equal to or greater than a radius of curvature of a corner portion of the battery cells adjacent to the spacer.

15. The battery pack of claim 12, wherein a protrusion protrudes from the side surface of at least one of the upper portion and the lower portion of the spacer toward the battery cells.

16. The battery pack of claim 12, wherein the spacer further comprises a blocking unit integral with the spacer and extending in a direction generally perpendicular to a length direction of the spacer.

17. The battery pack of claim 16, wherein the blocking unit contacts one surface of one of the battery cells located at either side of the spacer.

18. The battery pack of claim 12, wherein a length of the spacer is greater than a length of the battery cells, and wherein one end portion of the spacer protrudes past the battery cells toward the protection circuit module.

19. A battery pack comprising:
a plurality of battery cells arranged side-by-side in a first direction;
a protection circuit module electrically connected to the plurality of battery cells; and
a spacer located between neighboring battery cells and covering a side surface of each of the neighboring battery cells,
wherein corner portions of the battery cells are rounded, wherein a side surface of at least one of an upper portion and a lower portion of the spacer is rounded, and
wherein a radius of curvature of the side surface of the at least one of the upper portion and the lower portion of the spacer is equal to or greater than a radius of curvature of the corner portion of the battery cells adjacent to the spacer.

20. The battery pack of claim 19, wherein a protrusion protrudes from the side surface of the at least one of the upper portion and the lower portion of the spacer toward the battery cells.
